(19) United States
(12) Patent Application Publication
(10) Pub. No.: US 2015/0050974 A1
(43) Pub. Date: Feb. 19, 2015

(54) METHOD USING ODD OR EVEN NUMBERICAL SEQUENCE TO MAKE A 3 CARD POKER HAND TO BE USED AS A SIDE WAGER IN ANY 3 CARD POKER OR VIDEO GAME

(71) Applicant: JAMES ALVIN JONES, FORT LUPTON, CO (US)

(72) Inventor: JAMES ALVIN JONES, FORT LUPTON, CO (US)

(21) Appl. No.: 14/462,233

(22) Filed: Aug. 18, 2014

Related U.S. Application Data
(60) Provisional application No. 61/866,912, filed on Aug. 16, 2013.

(51) Int. Cl. G07F 17/32; A63F 1/00

(52) U.S. Cl. CPC G07F 17/3293; A63F 1/00; G07F 17/3244; A63F 2001/005
USPC 463/13; 273/292

(57) ABSTRACT

Disclosed are a method and an electronic gaming device for conducting a 3-card side odd/even wagering game associated with a primary wagering game. A player may make a side wager for a 3-card odd/even game in addition to regular play of the primary wagering game. Three cards dealt for the primary wagering game, including at least one card from the player hand in the primary game, are selected to form the player hand for the 3-card odd/even side game. The 3-card odd/even side game player hand is compared to odd/even combination award criteria in order to determine a reward/payout for the player or that the wager is lost for the 3-card odd/even side game. The three cards in a three card poker hand or the three cards used in a Blackjack +3 wagering game may be well suited to comprise the three cards that of the 3-card odd/even player hand.

### CROSS REFERENCE TO RELATED APPLICATIONS

This application is claims priority to U.S. provisional application Ser. No. 60/866,912, filed Aug. 16, 2014, entitled “A Method Using Odd or Even Numerical Sequence to Make a 3 Card Poker Hand to be Used as a Side Wager in Any 3 Card Poker or Video Game,” all of which is specifically incorporated herein by reference for all that it discloses and teaches.

### BACKGROUND OF THE INVENTION

Over the years many card games have been devised to permit an enjoyable pastime for people playing the card games. Some card games require special cards specific to the particular game, while other card games have used a “standard” deck of playing cards that consists of fifty-two playing cards. The fifty-two playing cards of a “standard” deck of playing cards are typically comprised of four each of cards with numerical values of 1-10, plus “face” cards designated as jacks, queens, and kings. The card with a numerical value of “1” is often referred to as an “Ace.” Typically, the jack, queen, and king are assigned a value greater than the 10 card in ascending value from jack to queen to king. Some games value the Ace card as the highest valued card while other games value the Ace card as the lowest valued card. In still other games, the Ace is permitted to be used as the highest or lowest valued card at the discretion of the player. Of the four cards of each value/face, there is typically one card of each of four separate “suits.” The four suits of a standard deck of playing cards are hearts, diamonds, clubs, and spades. Hearts and diamonds typically appear in red while clubs and spades typically appear in black. Accordingly, a standard deck of playing cards may be said to be comprised of Ace through king (13 cards) of each of the four suits of hearts, diamonds, clubs, and spades. In some instances, two additional “joker” cards without suit have been added to the deck to provide for additional playing options. Thus, a standard deck, including jokers, would contain fifty-four playing cards, while without the jokers the deck would contain fifty-two playing cards.

In order to add further entertainment to some of the card games, wagering, or monetary/barter betting, has been added to permit the players to bet on the outcome of the card game. The addition of wagering has further resulted in many card games being developed specifically for the purpose of providing a wagering game based on the play of the card game. Wagering card games have become a large business over the years and many wagering card games are provided for entertainment purposes at casinos around the world.

### SUMMARY OF THE INVENTION

An embodiment of the present invention may comprise a method of conducting a 3-card side odd/even wagering game associated with a primary wagering game comprising: receiving a wager related to the 3-card side odd/even wagering game; generating at least one random hand of playing cards in a primary wagering game from a set of randomly ordered physical playing cards such that the at least one random hand of playing cards includes a player hand; selecting three cards from playing cards making up the at least one random hand of playing cards that includes at least one card from the player hand in order to form a 3-card side odd/even player hand; comparing the 3-card side odd/even player hand to odd/even combination award criteria; determining a reward/payout in accord with the odd/even combination award criteria when it is determined that the 3-card side odd/even player hand satisfies the odd/even combination award criteria; determining that the 3-card side odd/even player hand loses when it is determined that the 3-card side odd/even player hand does not satisfy the odd/even combination award criteria; and settling the wager related to the 3-card odd/even wagering game by providing the reward/payout when it is determined that the 3-card side odd/even player hand satisfies the odd/even combination award criteria or collecting the wager related to the 3-card side odd/even wagering game when the odd/even player hand loses by not satisfying the odd/even combination award criteria.

An embodiment the invention may further be described as an embodiment of the above described method wherein: the primary wagering game is comprised of a three card poker game, and the three cards selected to form the 3-card side odd/even player hand are comprised of three cards that make up the player hand for the three card poker game that is the primary wagering game.

An embodiment the invention may further be described as an embodiment of the above described method wherein: the primary wagering game is comprised of a Blackjack game, the process of generating the at least one random hand of playing cards in the primary wagering game includes forming at least a dealer hand in addition to the player hand; and the three cards selected to form the 3-card side odd/even player hand are comprised of two cards that are initially dealt in the player hand for the Blackjack game that is the primary wagering game plus an initial face up card of the two cards initially dealt in the dealer hand for the Blackjack game that is the primary wagering game.

An embodiment of the present invention may further comprise an electronic gaming device for providing a 3-card side odd/even wagering game associated with a primary wagering game comprising: a display subsystem that displays a virtual representation of the primary wagering game and the 3-card side odd/even wagering game; an input/output subsystem that delivers the virtual representation of the primary wagering game and the 3-card side odd/even wagering game, receives player input for playing the primary wagering game and the 3-card side odd/even wagering game including receipt of a wager related to the 3-card side odd/even wagering game, and provides a reward/payout when it is determined that a 3-card side odd/even player hand satisfies odd/even combination award criteria; and a computing/processing subsystem that generates at least one random hand of playing cards in a primary wagering game from a virtual representation of a set of randomly ordered playing cards such that the at least one random hand of playing cards includes a player hand, selects three cards from playing cards making up the at least one random hand of playing cards that includes at least one card from the player hand in order to form the 3-card side odd/even player hand, compares the 3-card side odd/even player hand to the odd/even combination award criteria, determines a reward/payout in accord with the odd/even combination award criteria when the 3-card side odd/even player hand satisfies the odd/even combination award criteria, determines that the 3-card side odd/even player hand loses when the 3-card side odd/even player hand does not satisfy the odd/even combination award criteria; and settles the wager related to the 3-card odd/even wagering game by instructing the input/output subsystem to provide the reward/payout when it is determined that the 3-card side odd/even player hand satisfies the odd/even combination award criteria or collecting the wager from the input/output subsystem related to the 3-card side odd/even wagering game when the odd/even player hand loses by not satisfying the odd/even combination award criteria.

An embodiment the invention may further be described as an embodiment of the above described electronic gaming device wherein: the primary wagering game is comprised of a three card poker game, and the three cards selected to form the 3-card side odd/even player hand are comprised of three cards that make up the player hand for the three card poker game that is the primary wagering game.

An embodiment the invention may further be described as an embodiment of the above described electronic gaming device wherein: the primary wagering game is comprised of a Blackjack game, the generation of the at least one random hand of playing cards in the primary wagering game includes forming at least a dealer hand in addition to the player hand; and the three cards selected to form the 3-card side odd/even player hand are comprised of two cards that are initially dealt in the player hand for the Blackjack game that is the primary wagering game plus an initial face up card of the two cards initially dealt in the dealer hand for the Blackjack game that is the primary wagering game.

### BRIEF DESCRIPTION OF THE DRAWINGS

In the drawings,

FIG. 1 is a flow chart of the conduct of a 3-card side odd/even wagering game for an embodiment.

FIG. 2 is a schematic diagram of system components of an electronic gaming device embodiment for a virtual representation of a 3-card side odd/even wagering game.

FIG. 3 is a schematic diagram of a three card poker wagering game table layout of an embodiment with three card poker as the underlying primary wagering game and that includes a location for selection and wagering for a 3-card side odd/even wagering game.

FIG. 4 is schematic diagram of a blown up view for a single player position layout of the three card poker table layout for an embodiment with three card poker as the underlying primary wagering game and that includes a location for selection and wagering for a 3-card side odd/even wagering game.

FIG. 5 is a schematic diagram of a Blackjack wagering game table layout of an embodiment with Blackjack as the underlying primary wagering game and that includes a location for selection and wagering for a 3-card side odd/even wagering game.

FIGS. 6A-E are illustrations of various three card hands that meet odd/even combination award criteria for an embodiment of a 3-card side odd/even wagering game.

### DETAILED DESCRIPTION OF THE EMBODIMENTS

Casinos are in the business of providing entertainment to customers by providing opportunities to play various wagering games for entertaining play of the customers. Many of the wagering games may be games based on a standard deck of playing cards, some with, and some without the two joker cards included. A casino may benefit by providing a variety of wagering games to appeal to as broad of a customer base as possible. Further, a casino may benefit by providing new and different wagering games and/or new and different wagering options for existing wagering games so as to keep the wagering game options exciting, new and vibrant to both new and old customers alike.

In order to add to the excitement and enjoyment factor of a particular wagering game, additional wagering opportunities may be added to the game through a “side” wager. That is, in addition to the typical wagering opportunity of the game play for a wagering game, an additional “side” wager associated with some aspect of the primary wagering game may be added to the game. The “side” wager may be optional (i.e., at the discretion of the player) or may be mandatory (i.e., required for game play of the primary wagering game). For primary wagering games that use a standard deck of playing cards, a side wager may use the cards dealt for the primary wagering game to provide an additional betting opportunity. For example, a blackjack +3 wagering game may implement a side wager using a three card poker hand (see below for additional discussion of blackjack and/or three card poker rules) where the “side” wager on the primary blackjack wagering game may involve awards for various three card poker hands formed using the first two cards dealt to a player plus the face up card dealt to the blackjack dealer. With the side wager, a player has additional opportunities to win while playing a primary wagering game such that the player as well as those watching game play may experience additional excitement and enjoyment of the side wagering game. The casino may also benefit from the addition of a side wager as the side wager permits additional wagering opportunities during the same time it takes to play a regular primary wagering game.

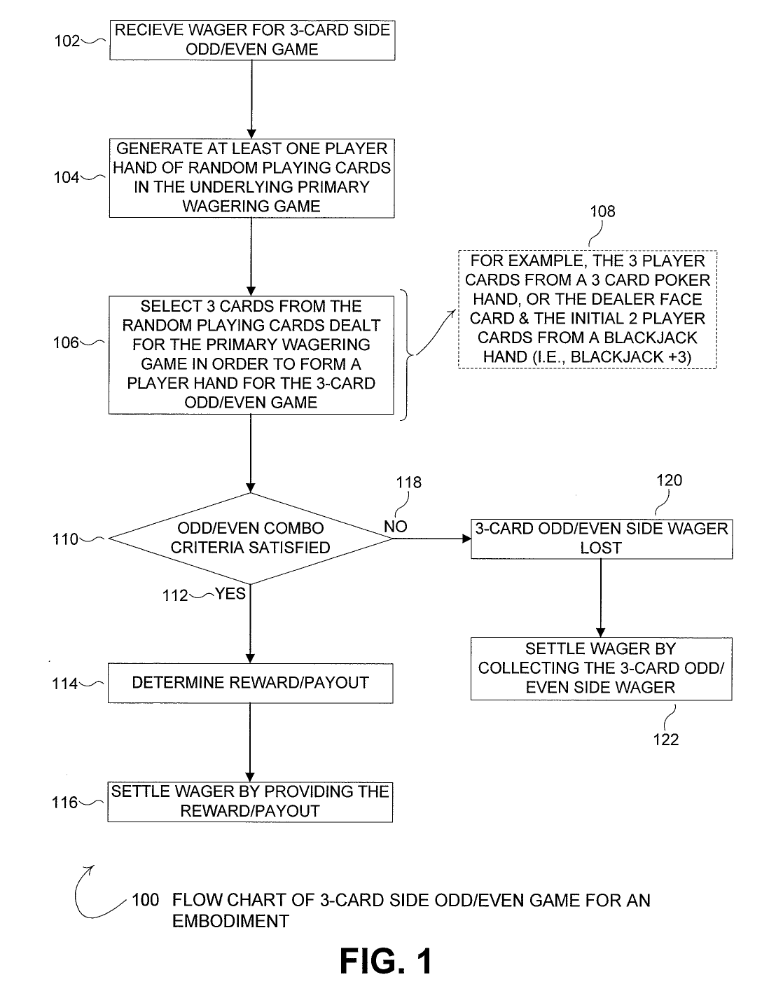

FIG. 1 is a flow chart 100 of the conduct of a 3-card side odd/even wagering game for an embodiment. The 3-card side odd/even game is based on play with a standard playing deck of playing cards. Various embodiments may either include or exclude the two joker cards such that the standard playing card deck may be comprised of fifty-two or fifty-four cards depending on whether or not the two joker cards are included in the deck. Various embodiments may utilize a physical deck of standard playing cards randomly ordered before being dealt to game players. Other embodiments may utilize a virtual representation of the randomly ordered standard deck of playing cards where the virtual representation is performed by a computing or processing device via a random number generator designed to virtually represent a randomly ordered standard deck of playing cards. In some wagering games, to ensure that players have greater difficulty in predicting what cards are available where cards of other players are shown to the players during game play, such as for the blackjack wagering game, multiple decks of standard playing cards (either with or without the two jokers depending on the wagering game) may be used during game play. Accordingly, various embodiments may be adapted for play with multiple decks of standard playing cards.

An embodiment of the 3-card side odd/even wagering game is played as a “side” game of a primary wagering game. That is, the 3-card side odd/even wagering game is played in addition to and associated with an underlying primary wagering game. Conceptually, the 3-card side odd/even game may be thought of as a child of the associated parent/primary game that underlies the game play of the side game. Accordingly, as the various embodiments of the 3-card side odd/even game are based on play using a standard deck of playing cards, either with or without jokers, the primary game associated with and/or underlying the 3-card side odd/even game should also be based on play using a standard deck of playing cards. Ultimately, the 3-card side odd/even wagering game will use three playing cards to form a 3-card side odd/even player hand. Therefore, play of the primary wagering game should permit selection of three cards to form the 3-card side odd/even player hand. In order to associate the 3-card side odd/even game with the primary/parent game, at least one card forming the 3-card side odd/even player hand should come from the player hand of the associated and/or underlying primary game.

There are many potential primary wagering games that may be adapted to permit play of an embodiment of the 3-card side odd/even wagering game. For instance, various poker card wagering games may utilize hands of 2 or more cards for game play. Typical poker card games utilize hands of cards that have between 3 and 7 total cards. Some poker games also include “community” cards shared by all players in the total count of cards for a hand. For instance, the currently popular game of Texas Hold'Em deals two cards to each player and five community cards shared by all players such that each player has a seven card hand made up of the two player hand cards and the five community cards. Other poker games, such as Pai Gow poker, may perform game play making up multiple sub-hands from a single dealt player hand. For instance, a typical Pai Gow poker game deals seven cards to each player hand and the player separates the seven cards into what the player feels is the best combination of a two-card sub-hand (i.e., pairs and high cards) and a typical five-card poker sub-hand (see below for further discussion of typical poker hand rules). In order to win at Pai Gow, the two-card sub-hand must beat the other two-card sub-hands and the five-card sub-hand must beat the other five-card sub-hands. If only one of the two-card or five-card hands is best, the play is considered a tie.

Typically the various poker games are played using at least one standard fifty-two card deck of playing cards. There are four suits (hearts, diamonds, clubs, and spades) of each sequence of cards. Each suit of cards may be comprised of an Ace, which may be played as the highest ranking card Ace, or may be played as the lowest ranking card number 1. There are also nine numbered cards numbered 2 thru 10 and three cards called face cards being a Jack, a Queen, and a King, for a total of thirteen cards of each suit and a grand total of fifty-two cards for a standard deck of cards (excluding jokers). Typically, various poker games are played by defining that a set of standard predetermined combinations of cards form winning hands with a hierarchy as to which combinations of cards are better. For a typical poker game, listed in sequence from lowest value to highest value, the predetermined combinations that determine winning hands are: High Card (highest card in the hand is higher than the highest card in the hands of other players), Pairs (a pair of the same value card such as a pair of Aces), Three of a Kind (three cards having the same value such as three Aces), Straights (all cards in the hand in sequence such as a four-five-six-seven-eight of any suit), Flushes (all cards in the hand having the same suit, aka. all cards are “suited”), Four of a Kind (having all four cards of a single value such as all four Aces), Straight Flushes (all cards in the hand in sequence such as a four-five-six-seven-eight and all cards having the same suit, i.e., suited), and Royal Flushes (a Straight Flush made up of the highest ranked cards such as the ten-jack-queen-king-ace combination for a five card hand). The various versions of poker games may use three, four, five, six or seven cards to make playable hands of poker, but still use the typical ranked sequence of predetermined combinations of cards described above to determine winning hands. In some poker games, the poker hand is based on the best five-card sub-hand when a player is dealt more than five cards in a hand or when there is a combination of more than five cards, including community cards, available to the player (such as is the case for Texas Hold'Em). Some poker games alter the ranking of winning hands based on the number of cards in play as well as the odds ratio for these combinations. For example, in a three card poker game the sequence of winning hands listed from lowest rank to highest may be: High Card, Pairs, Flushes, Straights, Three of a Kind and Straight Flushes. Other than the re-ordering of the ranks of the hands, the various winning poker hands still follow the standard predetermined combinations for poker hands.

In some poker games a “wild card” may be designated that may be used by the player to represent any card the player desires. For instance, if two's are designated as wild cards, a two of any suit may be used in place of a missing jack in a suited sequence of a ten-two (being played as a wild card version of the jack)-queen-king-ace to form a royal flush. Many times, two jokers are added to the standard fifty-two card deck of playing cards to form a fifty-four card deck of cards and the jokers are used as wild cards during game play. The designation of wild cards is typically performed prior to game play to ensure that the rules are fairly enforced during game play.

Blackjack (aka. “21” or twenty-one) is another common wagering game based on game play utilizing one or more standard decks of playing cards. In a typical game of blackjack, the hand that comes closest to adding up to twenty-one without going over is considered the winning hand. If more than one hand ties for the total value of the hand (e.g., more than one hand adds up to a total of twenty), the hand utilizing the fewest cards to reach the total value is deemed the winning hand. For a typical game of Blackjack, the Ace may be used as a value of one or a value of eleven, at the discretion of the player, and face cards are given a value of ten for game play. The best hand is a “blackjack” hand formed by an Ace and a ten/face card that adds up to a total of twenty-one using just two cards. In a typical game of Blackjack at a casino, each player plays a hand against a dealer hand to determine a winner. Game play of a typical game of Blackjack initially deals two cards to each player hand and two cards to a dealer hand. Typically the dealer hand is dealt with one card face up and a second card face down. The player may then request additional cards in order to attempt to get as close to a total value of twenty-one as possible. If the total value exceeds twenty-one, the player is said to have “busted” and loses the hand and the wagered amount to the casino. After each player has finished requesting additional cards, the dealer is typically required to request cards until the dealer hand reaches a value of seventeen. If the dealer “busts” all non-busted player hands win. If the dealer does not bust, all player hands with a total exceeding the dealer also win. A win typically pays out on a 1:1 ratio, but a “blackjack” hand of two cards totaling twenty-one for a player (i.e., an Ace and a ten/face card) may pay an additional bonus amount. If a player and the dealer tie, there may be a “push” where the player wager is returned to the player without any additional reward. At some casinos, a tie is considered a win by the dealer and the casino collects the wager of the player.

Blackjack or poker may be played against all of the other players at a table or each player may individually play against a dealer hand. When played against all other players at a table, all bets may be placed in a pot, and the pot is won by the best player hand. In the case of ties, the pot may be split among the tied players. For Blackjack, if all players bust, the pot may be added to the pot of a subsequent game. In many casinos, it is desirable to offer individual players the ability to bet one-on-one against the casino for various games. As described above, Blackjack is commonly played as several individual games at a single table where the determination of winning for each player is based off of play of the player hand versus a dealer hand. Three card poker is also commonly played in the same manner with each individual player hand being played against the casino dealer hand to determine a winner. Having each individual player hand play against the dealer permits multiple winners (and additional excitement) for game play as well as providing an opportunity for individual players to play a game without the need to locate other players in order to permit game play.

Ultimately, the availability of at least three dealt cards to any hand in the underlying primary game (e.g., poker or Blackjack), with at least one card in the player hand of the underlying primary game permits the formation of a three card hand for use as the 3-card side odd/even player hand in the various embodiments. Thus, any primary game that has at least three dealt cards to any hand in the underlying primary game, with at least one card in the player hand of the underlying primary game may be used as the underlying primary game for the 3-card side odd/even wagering game (see below for additional discussion of the selection 106 of the three cards of a 3-card side odd/even player hand). While it is more common to have a side wager associated with a primary game made up of multiple individual player hands played against a dealer hand (as described in more detail above for a Blackjack game), it is possible to play a side game for a payout by the casino even when a primary game is played against other players for a common “pot” of wagers. All that is necessary is that the 3-card side odd/even wager be made available to players and that the formation of the 3-card side odd/even player hand be possible from the dealt cards of the underlying primary wagering game, including at least one card from a player hand of the underlying primary wagering game.

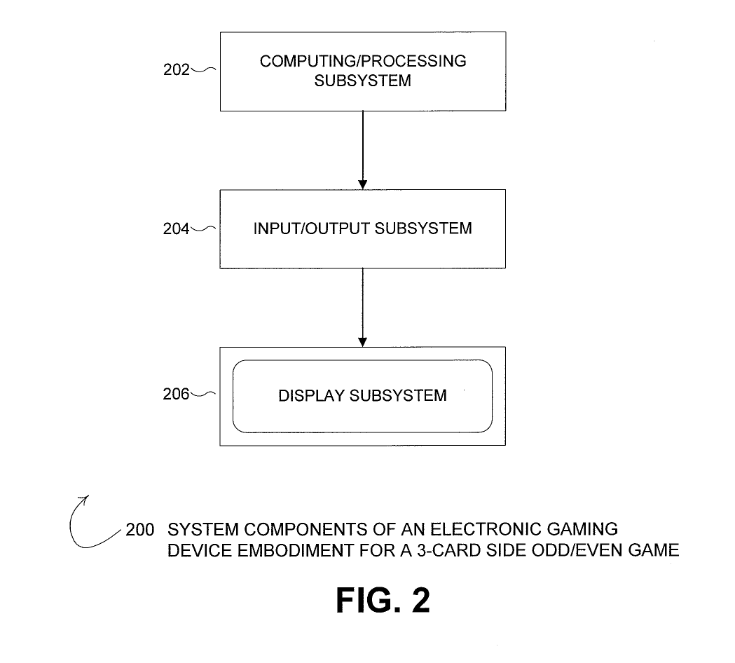

In the embodiment described in FIG. 1, play of the 3-card side odd/even wagering game begins when a wager for the 3-card side odd/even wagering game is received at 102. The receipt of the 3-card side odd/even wager at 102 may be accomplished at a physical table for playing a primary wagering game by placing the wager on the table, typically in a location on the table designated for the 3-card side odd/even wager, such as a circle with the term “odd/even” written within the circle. For a virtual game on an electronic gaming device, a cash or card (credit, debit, or cash) input/output subsystem (e.g., 204 of FIG. 2) of the electronic gaming device may receive 102 the 3-card side odd/even wager. The receipt 102 of a 3-card side odd/even wager may be an optional part of the underlying primary game or it may be a requirement in order to play the underlying primary game, at the discretion of the game provider (typically a casino). In general, for a virtual game embodiment operating on an electronic gaming device, a computing/processing subsystem (e.g., 202 of FIG. 2) may provide the ability to compare, select, compute, determine and/or otherwise process values in a computing/processing subsystem (e.g., 202 of FIG. 2) of the electronic gaming device. Interaction to receive or provide money, user choices or other data to/from the electronic gaming device may be provided by an input/output subsystem (e.g., 204 of FIG. 2) of the electronic gaming device. Display to the user of the status and/or play of the 3-card side odd/even game and/or the underlying primary wagering game may be shown to the user on a display subsystem (e.g., 206 of FIG. 2) of the electronic gaming device. For a physical game embodiment, a person (typically the dealer) may handle the compare, select, compute, determine, input, output, and/or other processing functions while the physical play of the cards provides the game play mechanism and the display of the game to the user. Electronic aids, such as a calculator, may be utilized to assist in determining payouts/rewards, etc.

At process 104, at least one player hand for the underlying primary wagering game is generated using the physical (for game play at a live table) or virtual (for game play on an electronic gaming device) deck, or multiple decks, of playing cards that have been placed in random order. For the physical deck, or decks, of cards, the randomness may be achieved by physically shuffling the cards. For the virtual deck, or decks, of cards, the randomness may be provided by a random number generator adapted to simulate the one or more decks used by the underlying primary game. In the case where all three cards that will make up the 3-card side odd/even player hand are obtained solely from the player hand for the underlying primary game (e.g., the three cards of a three card poker hand), it is only necessary that the player hand of the underlying primary game be dealt in order to play the 3-card side odd/even wagering game. In practice, it is likely that the underlying primary game will be played in whole, or at least in part, before the 3-card side odd/even game is played, meaning other player and/or dealer hands are also dealt. However, if one or more cards that will make up the 3-card side odd/even player hand are obtained from a source other than the player hand of the underlying primary game, then, for those embodiments, other hands may also need to be dealt to accommodate game play of the 3-card side odd/even game. For instance, in games such as Blackjack or Texas Hold'Em, the player hand is only guaranteed to be comprised of two cards, so the third card in the 3-card side odd/even game may be obtained from other sources, such as, perhaps, the face up card of the dealer hand for Blackjack or a designated one of the four community cards played for Texas Hold'Em. Accordingly, it may be necessary in certain embodiments to deal more than just the player hand in the underlying primary wagering game before play of the 3-card side odd/even wagering game is possible.

At process 106, the three cards from the random playing cards dealt for the underlying primary wagering game in process 104 are selected to form a player hand for the 3-card side odd/even wagering game. In a virtual representation of the 3-card side odd/even wagering game, the selection of the three cards in the 3-card side odd/even player hand may be performed automatically by a computing/processing subsystem (e.g., 202 of FIG. 2) of the electronic gaming device if player input is not needed, or may be selected by a computing/processing subsystem (e.g., 202 of FIG. 2) with input received from the player by an input/output subsystem (e.g., 204 of FIG. 2) of the electronic gaming device when there is a decision to be made by a player.

As described at 108, the selection of the three cards for the 3-card side odd/even player hand may be drawn from three card selections already used in, or associated with, the underlying primary wagering game. For instance, the three cards of the player hand of the underlying primary game of three card poker may be used to form the 3-card side odd/even player hand. In Blackjack, the three cards of a Blackjack +3 side wager may similarly be used as the three cards that make up the 3-card side odd/even player hand. That is, the initial two cards dealt to the player in the player hand of Blackjack, plus the face up card of the dealer hand of Blackjack may be used to form the 3-card side odd/even player hand. While potentially more complicated, other variations of embodiments using Blackjack as the underlying primary game may provide that, when played, the first three cards of the player hand be selected as the three cards of the 3-card side odd/even player hand. Still other embodiments with Blackjack as the underlying primary game may permit the player to optionally select either the face up dealer card, the face down dealer card, or additional cards dealt into the player hand as the third card in addition to the two cards initially dealt into the player hand for the underlying primary Blackjack game. Ultimately, one skilled in the art will recognize that any manner of selecting the three cards to form the 3-card side odd/even player hand from the cards dealt for the underlying primary game may be utilized provided that at least one card from a player hand of the underlying primary game is included in the 3-card side odd/even player hand in order to associate the side game with the underlying primary game.

One skilled in the art will further recognize that other games may be adapted for the three card selection process of 106 that forms the 3-card side odd/even player hand. For instance, in Texas Hold'Em, the two cards dealt to the player plus one of the community cards may be used to form the 3-card side odd/even player hand. Which of the four community cards used for the third card may be fixed by the rules of the embodiment of the 3-card side odd/even game, or the player may be permitted to select which community card to use, either before the community cards are dealt, or even after the community cards are dealt if additional advantage for the player is desired. For a four, five, six, seven, or more card poker game, the first three, last three, middle three, or some other pre-designated order of dealt cards in a player hand of the underlying primary poker game may be used to define/select the 3-card side odd/even player hand. Again, if additional advantage to the player is desired, the choice of three cards from the player hand of the underlying primary poker game may be left to the player after the cards are dealt. Again, one skilled in the art will recognize that any manner of selecting the three cards to form the 3-card side odd/even player hand from the cards dealt for the underlying primary game may be utilized provided that at least one card from a player hand of the underlying primary game is included in the 3-card side odd/even player hand in order to associate the side game with the underlying primary game.

At process 110, the 3-card side odd/even player hand selected at process 106 is compared to odd/even combination award criteria. For a virtual representation of an embodiment of the 3-card side odd/even wagering game, a computing/processing subsystem (e.g., 202 of FIG. 2) of an electronic gaming device may perform the comparison of the 3-card odd/even player hand to the odd/even combination award criteria. The odd/even combination award criteria provides a new and unique criteria for determining awards for a wagering game by introducing odd or even requirements into winning card sequences as defined by the odd/even award criteria. The three card hands that win utilizing odd/even award criteria do not win under typical poker rules. Thus, the odd/even award criteria provide players a secondary means to win despite a hand that does win, or is not as valuable, under typical poker award criteria (see above).

An embodiment may define odd/even award criteria by first defining cards with an odd numerical number sequence as being the 1 (Ace), 3, 5, 7, and 9 and cards with an even numerical sequence as being the 2, 4, 6, 8, and 10. Some embodiments may restrict the available odd and/or even cards to the numeric cards of 1 (Ace) through 10, and leave the face cards (jack, queen, and king) and/or the jokers as null cards that cannot be used to satisfy the odd/even award criteria. Other embodiments may designate one or more of the face cards and/or the joker to have an odd or even characteristic as well as having a value in the sequence of numbers. For instance, an embodiment may designate that the jack, queen, and king follow in sequence from the 10 card such that the jack is odd with a sequence value of 11, the queen is even with a sequence value of 12, and the king is odd with a sequence value of 13. If jokers are available in the playing deck of the underlying primary game, the joker may further be designated as an even with a sequence value of 14. One skilled in the art will recognize that one or more of the face cards and/or joker may be designated odd or even with whatever sequence value is desired by the game provider as long as the game players are informed of and understand the rules.

For various embodiments, the odd/even award criteria may include one or more of the following winning hand criteria, listed in order from lowest rank to highest rank where similar odd and even criteria are equal (odd was arbitrarily chose to be listed first).

ALL ODD: All three cards in the 3-card side odd/even player hand are odd cards regardless of suit (e.g., 3, 7, 9).

ALL EVEN: All three cards in the 3-card side odd/even player hand are even cards regardless of suit (e.g., 2, 6, 10).

ODD PAIR: A pair of two odd cards plus the third card is also an odd card regardless of suit (e.g., 3, 3, 7).

EVEN PAIR: A pair of two even cards plus the third card is also an even card regardless of suit (e.g., 4, 4, 8).

ODD FLUSH: All three cards in the 3-card side odd/even player hand are odd cards and all three cards are of the same suit (i.e., are suited) (e.g., 3, 7, 9 all of hearts).

EVEN FLUSH: All three cards in the 3-card side odd/even player hand are even cards and all three cards are of the same suit (i.e., are suited) (e.g., 2, 6, 10 all of spades).

ODD STRAIGHT: All three cards in the 3-card side odd/even player hand are odd cards and are in odd numerical order regardless of suit (e.g., 3, 5, 7).

EVEN STRAIGHT: All three cards in the 3-card side odd/even player hand are even cards and are in even numerical order regardless of suit (e.g., 6, 8, 10).

ODD STRAIGHT FLUSH: All three cards in the 3-card side odd/even player hand are odd cards, are in odd numerical order, and are all of the same suit (i.e., are suited) (e.g., 3, 5, 7 of diamonds).

EVEN STRAIGHT FLUSH: All three cards in the 3-card side odd/even player hand are even cards, are in even numerical order, and are all of the same suit (i.e., are suited) (e.g., 2, 4, 6 of clubs).

ODD ROYAL FLUSH: All three cards in the 3-card side odd/even player hand are odd cards, are in odd numerical order, are all of the same suit (i.e., are suited), and are the highest available cards in the odd numerical order sequence (e.g., 9, jack, king of diamonds). Some embodiments may choose not to utilize the odd royal flush for embodiments that do not include face cards and/or jokers as the game provider may feel there is not sufficient probability differentiation from an odd straight flush if only using the numeric cards for the 3-card side odd/even game play of an embodiment.

EVEN ROYAL FLUSH: All three cards in the 3-card side odd/even player hand are even cards, are in even numerical order, are all of the same suit (i.e., are suited), and are the highest available cards in the even numerical order sequence (e.g., 8, 10, queen of hearts). Some embodiments may choose not to utilize the even royal flush for embodiments that do not include face cards and/or jokers as the game provider may feel there is not sufficient probability differentiation from an even straight flush if only using the numeric cards for the 3-card side odd/even game play of an embodiment.

Typically an embodiment will only reward the highest ranked award of the available awards, so a hand that is all odd and in sequence will only payout a reward for the odd straight criteria and not a reward for both the all odd and odd straight criteria separately. Also, the payout reward will typically increase with the decrease in probability of obtaining the winning hand from a random deck of playing cards. That is, an odd/even royal flush will pay significantly more than simply having all odd or even cards in a hand since an odd/even royal flush is far less likely to occur than a hand simply having all odd or even cards. Also, as with the underlying primary wagering game, one or more wild cards may be designated to be used by the player as desired to increase the rank of a 3-card side odd/even player hand. For instance, if jokers are included and a joker is a wild card, the hand 2-joker-6 would qualify as an even straight. Wild cards for the 3-card side odd/even wagering game may be inherited (i.e., the same as) wild cards from the underlying primary wagering game, and/or wild cards may be separately designated for the 3-card side odd/even wagering game.

Further, one skilled in the art will recognize that either odd or even attributes may be valued more greatly in order to provide additional variation and/or excitement for a game. Also, the odd/even wager may further be split to recognize oddness or evenness separately with the odd/even criteria also split appropriately and with award payouts adjusted accordingly to recognize the change in the odds to get only odd or only even cards.

If the odd/even combination award criteria of the 3-card side odd/even player hand is met 112 in process 110, the player qualifies for a reward/payout at process 114. At process 114, the reward/payout is determined based on the odd/even combination award criteria described above. Typically, the reward/payout increases as the probability of obtaining a winning hand under the odd/even combination award criteria decreases. Thus, the reward/payout for an odd straight flush would typically be larger than the reward/payout for an all odd hand. The amount of the reward/payout and/or the availability of some of the criteria listed in the odd/even combination award criteria above may vary with the underlying primary game, the choice of the game provider, the probability of obtaining a particular hand, and the choice of whether to include face cards and/or the joker as playable (i.e., non-null) cards in the 3-card side odd/even player hand. For a virtual game operating on an electronic game device, a computing/processing subsystem (e.g., 202 of FIG. 2) may be used to determine the payout/reward based on the particular award criteria of the odd/even combination award criteria met by the 3-card side odd/even player hand.

In an embodiment utilizing a fifty-two card deck of playing cards (i.e., without jokers) and only counting numeric cards (i.e., Ace-1 through 10) as playable cards in the 3-card side odd/even player hand, an embodiment may provide a reward/payout according to Table 1 below.

TABLE 1

| Criteria Met | Reward/Payout | Probability of Hand |
|---|---|---|
| Odd/Even Straight Flush | 25-40:1 | 0.109% |
| Odd/Even Straight | 5-8:1 | 1.74% |
| Odd/Even Flush | 3-5:1 | 2.17% |
| Odd/Even Pair | 1-3:1 | 1.69% |
| All Odd/Even | PUSH | 10.32% |

As described above, a “push” reward/payout is simply the return of the initial wager without any additional reward/payout. The reward/payout in odds form (e.g., 8:1) implies a payout of the odds value multiplied times the original wager (e.g., 8 times the original waver for 8:1 odds). One skilled in the art will recognize that the reward/payout may be adjusted to achieve desired game play enjoyment as well as desired profit for the game provider (typically a casino). For instance, a game provider may wish to increase the payout for Odd/Even Pair and higher ranked criteria and eliminate the “push” reward for all odd/even in order to more highly reward players who take a higher risk of losing money by not having the wager returned for an all odd/even hand.

At process 116, the wager of the player is settled by providing the reward/payout determined in process 114 above to the player. In a physical game embodiment, the dealer may provide the determined reward/payout to the player. In virtual game embodiment, an input/output subsystem (e.g., 204 of FIG. 2) of an electronic gaming device may provide the determined reward/payout to the player.

If the odd/even combination award criteria of the 3-card side odd/even player hand is not met 118 in process 110, the 3-card side odd/even game of the player is determined to be lost at process 120. For a virtual game operating on an electronic game device, a computing/processing subsystem (e.g., 202 of FIG. 2) may be used to determine that the player lost.

At process 122, the wager of the player is settled for a lost wager 120 by collecting the 3-card side odd/even wager. In a physical game embodiment, the dealer may collect the 3-card side odd/even wager. In virtual game embodiment, the computing/processing subsystem (e.g., 202 of FIG. 2) may simply retain the 3-card side odd/even wager received as may have been done by an input/output subsystem (e.g., 204 of FIG. 2) of the electronic gaming device at process 102 described above.

FIG. 2 is a schematic diagram 200 of system components of an electronic gaming device embodiment for a virtual representation of a 3-card side odd/even wagering game. For a virtual game embodiment operating on an electronic gaming device, a computing/processing subsystem 202 may provide the ability to compare, select, compute, determine and/or otherwise process values in a computing/processing subsystem 202 of the electronic gaming device. Interaction to receive or provide money, user choices or other data to/from the electronic gaming device may be provided by an input/output subsystem 204 of the electronic gaming device. Display to the user of the status and/or play of the virtual 3-card side odd/even game and/or the underlying virtual primary wagering game may be shown to the user on a display subsystem 206 of the electronic gaming device. For further detail, see also the description with respect to FIG. 1 above.

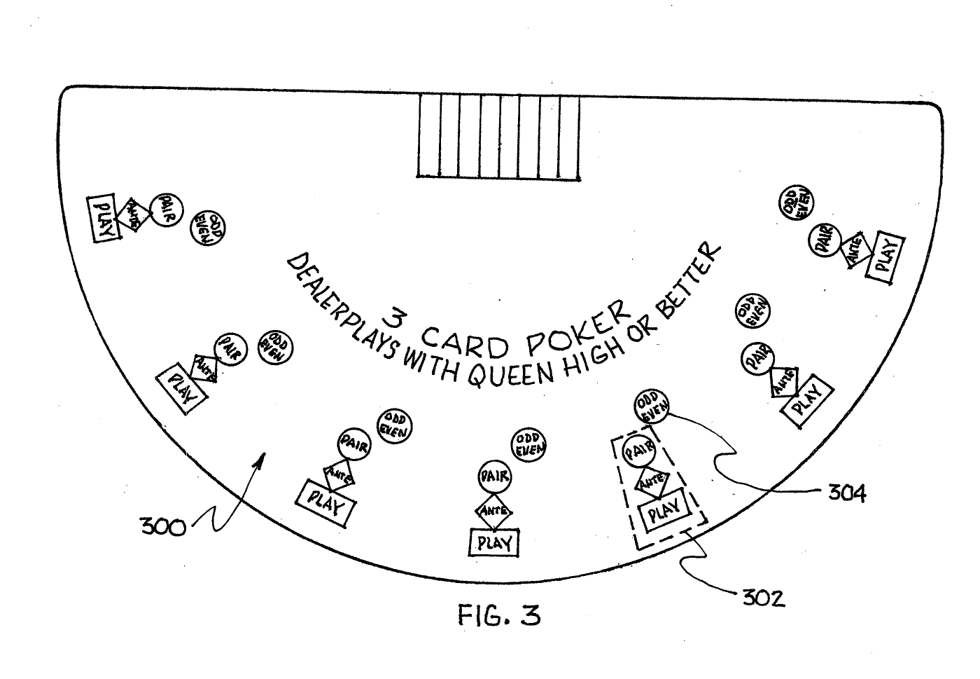

FIG. 3 is a schematic diagram of a three card poker wagering game table layout 300 of an embodiment with three card poker as the underlying primary wagering game and that includes a location 304 for selection and wagering for a 3-card side odd/even wagering game. The three card poker wagering game table layout 300 includes items 302 typically expected for the play of the underlying primary three card poker game. In addition to the typical items 302 for a three card poker game, an additional location 304 is identified on the table 300 for placing a wager for a 3-card side odd/even wagering game (see above for further detail). In the embodiment shown in FIG. 3, the location 304 for placing a wager to participate in a 3-card side odd/even wagering game is indicated by a circle enclosing the term “odd/even.”

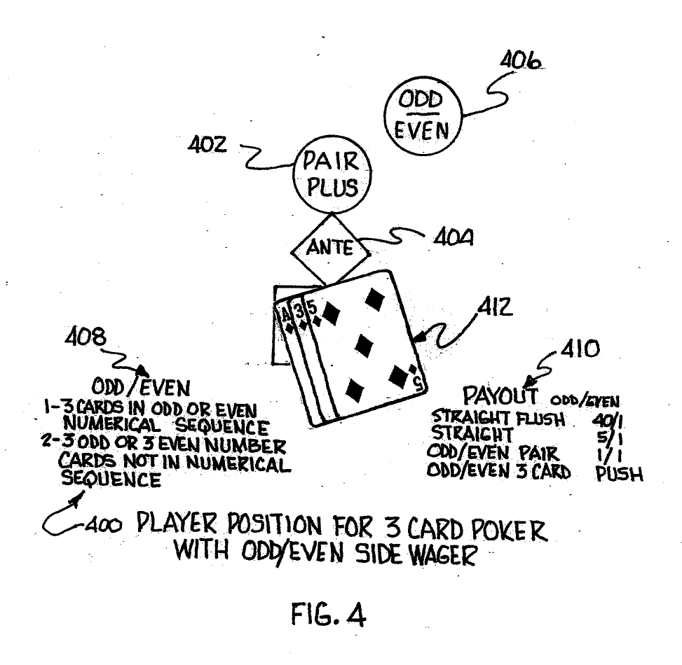

FIG. 4 is schematic diagram of a blown up view for a single player position layout 400 of the three card poker table layout for an embodiment with three card poker as the underlying primary wagering game and that includes a location 406 for selection and wagering for a 3-card side odd/even wagering game. For the embodiment shown in FIG. 4, desired rules for the embodiment may permit play of the 3-card side odd/even wagering game only after a player has placed a wager on the “pair plus” 402 location and/or placed a wager on the “ante” 404 location in order to play the underlying primary three card poker game. Play of the 3-card side odd/even wagering game is not included until an additional wager is placed on the 3-card side odd/even (i.e., odd/even) wager location 406. The single position layout 400 may also include helpful guides for the 3-card side odd/even game play 408 and/or a 3-card side odd/even reward/payout table 410. To assist the dealer in providing a fair game, card play 412 may be restricted to a particular location 412 on the table.

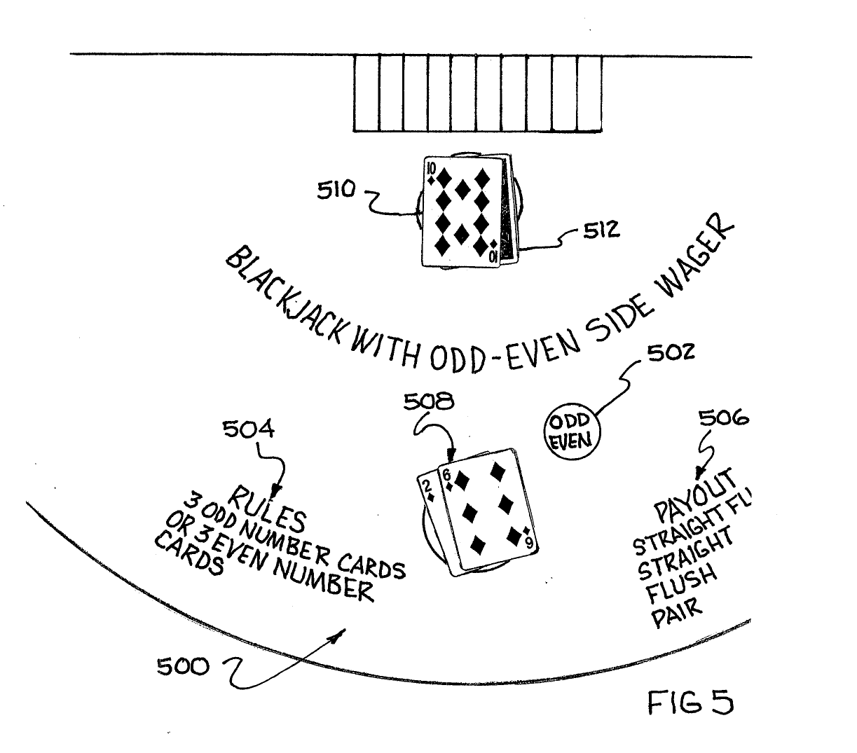

FIG. 5 is a schematic diagram of a Blackjack wagering game table layout 500 of an embodiment with Blackjack as the underlying primary wagering game and that includes a location 502 for selection and wagering for a 3-card side odd/even wagering game. For the embodiment shown in FIG. 5, play of the 3-card side odd/even wagering game is not included until an additional wager is placed on the 3-card side odd/even (i.e., odd/even) wager location 502. The Blackjack wagering game table single position layout 500 may also include helpful guides for the 3-card side odd/even game play 504 and/or a 3-card side odd/even reward/payout table 506. To assist the dealer in providing a fair game, card play 508 for a player may be restricted to a particular location 508 on the table. As shown in FIG. 5, the player hand 508 is comprised of a 2 and a 6 of diamonds. The dealer hand is shown with a face up card 510 and a face down card 512. For an embodiment that uses the underlying primary game of Blackjack and defines the three cards of the 3-card side odd/even game to be the two initial player cards 508 plus the face up dealer card 510, the 3-card side odd/even player hand shown in FIG. 5 is a 2, 6, and 10 all of diamonds, which would be an Even Flush in the odd/even combination award criteria described in more detail above.

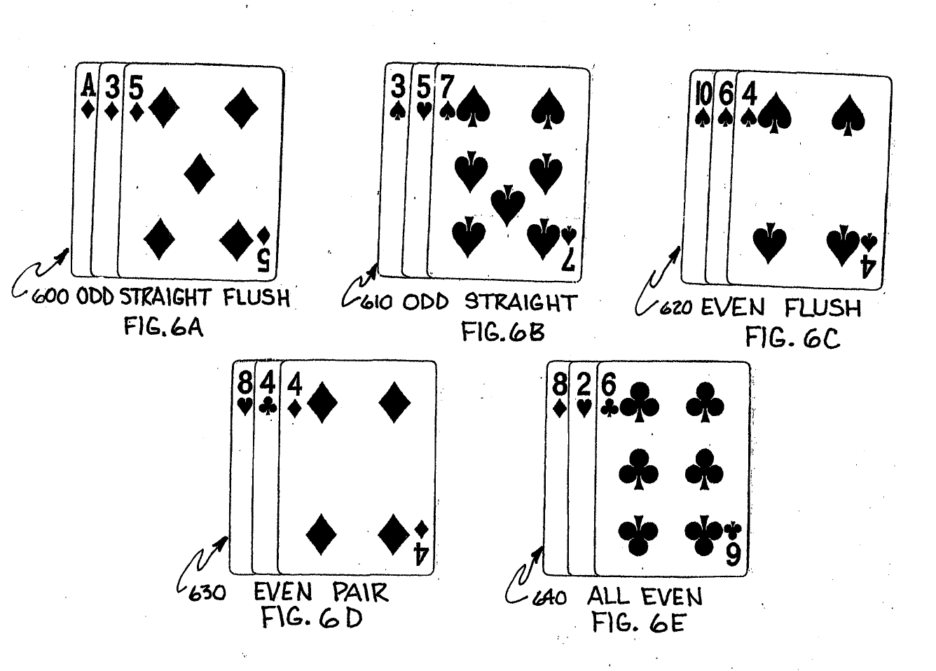

FIGS. 6A-E are illustrations 600-640 of various three card hands that meet odd/even combination award criteria for an embodiment of a 3-card side odd/even wagering game. FIG. 6A illustrates an Odd Straight Flush 600 made up of the odd numerical sequence of the Ace-1, 3, and 5 cards all of the same suit of diamonds. FIG. 6B illustrates an Odd Straight 610 made up of the odd numerical sequence of the 3, 5, and 7 cards but with different suits (i.e., 3 of hearts, and 5 and 7 of spades). FIG. 6C illustrates an Even Flush 620 made up of the even, but not even numerical sequence, 10, 6 and 4 cards all of the same suit of spades. FIG. 6D illustrates an Even Pair 630 made up of the all even cards with a pair of equivalently numbered cards including an 8 of hearts, the 4 of clubs and the 4 of diamonds. FIG. 6E illustrates an All Even card hand 640 made up of all even cards, not in even numerical sequence, and not of the same suit, including an 8 of diamonds, a two of hearts, and a 4 of clubs. The card combinations shown in FIGS. 6A-E are intended as examples of sample winning 3-card side odd/even wagering games winning hands, but are not intended to be an all encompassing illustration of winning hands. One skilled in the art will recognize that combinations of cards not shown in FIGS. 6A-E may also meet the above described odd/even combination award criteria for the 3-card side odd/even wagering game.

Various embodiments may provide the control and management functions for the electronic gaming device detailed herein via an application operating on a computer system (or other electronic devices). Embodiments may be provided as a computer program product which may include a computer-readable, or machine-readable, medium having stored thereon instructions which may be used to program/operate a computer (or other electronic devices) or computer system to perform a process or processes in accordance with the present invention. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

The foregoing description of the invention has been presented for purposes of illustration and description. It is not intended to be exhaustive or to limit the invention to the precise form disclosed, and other modifications and variations may be possible in light of the above teachings. The embodiment(s) were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of conducting a 3-card side odd/even wagering game associated with a primary wagering game comprising:
receiving a wager related to said 3-card side odd/even wagering game;
generating at least one random hand of playing cards in a primary wagering game from a set of randomly ordered physical playing cards such that said at least one random hand of playing cards includes a player hand;
selecting three cards from playing cards making up said at least one random hand of playing cards that includes at least one card from said player hand in order to form a 3-card side odd/even player hand;
comparing said 3-card side odd/even player hand to odd/even combination award criteria;
determining a reward/payout in accord with said odd/even combination award criteria when it is determined that said 3-card side odd/even player hand satisfies said odd/even combination award criteria;
determining that said 3-card side odd/even player hand loses when it is determined that said 3-card side odd/even player hand does not satisfy said odd/even combination award criteria; and
settling said wager related to said 3-card odd/even wagering game by providing said reward/payout when it is determined that said 3-card side odd/even player hand satisfies said odd/even combination award criteria or collecting said wager related to said 3-card side odd/even wagering game when said odd/even player hand loses by not satisfying said odd/even combination award criteria.

2. The method of claim 1 wherein:
said primary wagering game is comprised of a three card poker game, and
said three cards selected to form said 3-card side odd/even player hand are comprised of three cards that make up said player hand for said three card poker game that is said primary wagering game.

3. The method of claim 1 wherein:
said primary wagering game is comprised of a Blackjack game,
said process of generating said at least one random hand of playing cards in said primary wagering game includes forming at least a dealer hand in addition to said player hand; and
said three cards selected to form said 3-card side odd/even player hand are comprised of two cards that are initially dealt in said player hand for said Blackjack game that is said primary wagering game plus an initial face up card of said two cards initially dealt in said dealer hand for said Blackjack game that is said primary wagering game.

4. The method of claim 1 wherein said odd/even combination award criteria is comprised of at least one of a group consisting of: odd royal flush, even royal flush, odd straight flush, even straight flush, odd straight, even straight, odd flush, even flush, odd pair, even pair, all odd, and all even.

5. The method of claim 1 wherein during said comparing of said 3-card side odd/even player hand to odd/even combination award criteria, only numerical cards are considered (i.e., Ace to ten), where an Ace is understood to have a numerical value of one, such that non-numerical cards such as a jack, queen, king, or joker are considered to be null and cannot be used to positively satisfy said odd/even combination award criteria.

6. The method of claim 5 wherein:
said randomly ordered physical playing cards are comprised of a standard fifty-two card deck that excludes jokers; and
said reward/payout when using said standard fifty-two card deck is comprised of at least one of a group of payout ratios consisting of: 25-40:1 for an odd straight flush, 25-40:1 for an even straight flush, 5-8:1 for an odd straight, 5-8:1 for an even straight, 3-5:1 for an odd flush, 3-5:1 for an even flush, 1-3:1 for an odd pair, 1-3:1 for an even pair, push (i.e., return of wagered amount) for all odd, and push for all even.

7. The method of claim 1 wherein at least one type of non-numeric card comprised of card types jacks, queens, kings, and jokers is assigned to be odd or even and have a sequential value relative to Ace through 10 cards when performing said process of comparing said 3-card side odd/even player hand to said odd/even combination award criteria in order to include said at least one type of non-numeric card in play of said 3-card side odd/even wagering game.

8. The method of claim 1 wherein at least one card of said randomly ordered physical playing cards is designated as a wildcard such that said at least one card that is a wildcard is designated as a best possible card in terms of payout/reward for said 3-card side odd/even player hand when performing said process of comparing said 3-card side odd/even player hand to said odd/even combination award criteria.

9. An electronic gaming device for providing a 3-card side odd/even wagering game associated with a primary wagering game comprising:
a display subsystem that displays a virtual representation of said primary wagering game and said 3-card side odd/even wagering game;
an input/output subsystem that delivers said virtual representation of said primary wagering game and said 3-card side odd/even wagering game, receives player input for playing said primary wagering game and said 3-card side odd/even wagering game including receipt of a wager related to said 3-card side odd/even wagering game, and provides a reward/payout when it is determined that a 3-card side odd/even player hand satisfies odd/even combination award criteria; and
a computing/processing subsystem that generates at least one random hand of playing cards in a primary wagering game from a virtual representation of a set of randomly ordered playing cards such that said at least one random hand of playing cards includes a player hand, selects three cards from playing cards making up said at least one random hand of playing cards that includes at least one card from said player hand in order to form said 3-card side odd/even player hand, compares said 3-card side odd/even player hand to said odd/even combination award criteria, determines a reward/payout in accord with said odd/even combination award criteria when said 3-card side odd/even player hand satisfies said odd/even combination award criteria, determines that said 3-card side odd/even player hand loses when said 3-card side odd/even player hand does not satisfy said odd/even combination award criteria; and settles said wager related to said 3-card odd/even wagering game by instructing said input/output subsystem to provide said reward/payout when it is determined that said 3-card side odd/even player hand satisfies said odd/even combination award criteria or collecting said wager from said input/output subsystem related to said 3-card side odd/even wagering game when said odd/even player hand loses by not satisfying said odd/even combination award criteria.

10. The electronic gaming device of claim 9 wherein:
said primary wagering game is comprised of a three card poker game, and
said three cards selected to form said 3-card side odd/even player hand are comprised of three cards that make up said player hand for said three card poker game that is said primary wagering game.

11. The electronic gaming device of claim 9 wherein:
said primary wagering game is comprised of a Blackjack game,
said generation of said at least one random hand of playing cards in said primary wagering game includes forming at least a dealer hand in addition to said player hand; and
said three cards selected to form said 3-card side odd/even player hand are comprised of two cards that are initially dealt in said player hand for said Blackjack game that is said primary wagering game plus an initial face up card of said two cards initially dealt in said dealer hand for said Blackjack game that is said primary wagering game.

12. The electronic gaming device of claim 9 wherein said odd/even combination award criteria is comprised of at least one of a group consisting of: odd royal flush, even royal flush, odd straight flush, even straight flush, odd straight, even straight, odd flush, even flush, odd pair, even pair, all odd, and all even.

13. The electronic gaming device of claim 9 wherein for comparison of said 3-card side odd/even player hand to odd/even combination award criteria, only numerical cards are considered, (i.e., Ace to ten), where an Ace is understood to have a numerical value of one, such that non-numerical cards such as a jack, queen, king, or joker are considered to be null and cannot be used to positively satisfy said odd/even combination award criteria.

14. The electronic gaming device of claim 13 wherein:
said virtual representation of said set of randomly ordered playing cards is comprised of a virtual representation of a standard fifty-two card deck that excludes jokers; and
said reward/payout when using said standard fifty-two card deck is comprised of at least one of a group of payout ratios consisting of: 25-40:1 for an odd straight flush, 25-40:1 for an even straight flush, 5-8:1 for an odd straight, 5-8:1 for an even straight, 3-5:1 for an odd flush, 3-5:1 for an even flush, 1-3:1 for an odd pair, 1-3:1 for an even pair, push (i.e., return of wagered amount) for all odd, and push for all even.

15. The electronic gaming device of claim 9 wherein at least one type of non-numeric card comprised of card types jacks, queens, kings, and jokers is assigned to be odd or even and have a sequential value relative to Ace through 10 cards when performing said process of comparing said 3-card side odd/even player hand to said odd/even combination award criteria in order to include said at least one type of non-numeric card in play of said 3-card side odd/even wagering game.

16. The electronic gaming device of claim 9 wherein at least one card of said virtual representation of said set of randomly ordered playing cards is designated as a wildcard such that said at least one card that is a wildcard is designated as a best possible card in terms of payout/reward for said 3-card side odd/even player hand for said comparison of said 3-card side odd/even player hand to said odd/even combination award criteria.
